(19) United States
(12) Patent Application Publication
(10) Pub. No.: US 2026/0333108 A1
(43) Pub. Date: Oct. 22, 2026

(54) REDUNDANT STEERING MODE WITH STATIC DUPLICATION

(71) Applicant: InterDigital Patent Holdings, Inc., Wilmington, DE (US)

(72) Inventors: Rocco Di Girolamo, Laval (CA); Xavier De Foy, Kirkland (CA); Guanzhou Wang, Brossard (CA); Saad Ahmad, Montreal (CA)

(73) Assignee: InterDigital Patent Holdings, Inc., Wilmington, DE (US)

(21) Appl. No.: 19/115,815

(22) PCT Filed: Sep. 29, 2023
(86) PCT No.: PCT/US2023/034130

§ 371 Date: Mar. 27, 2025

Related U.S. Application Data
(60) Provisional application No. 63/411,411, filed on Sep. 29, 2022.

(51) Int. Cl. H04W 28/02; H04L 47/32; H04W 88/06

(52) U.S. Cl. CPC H04W 28/0215; H04L 47/32; H04W 28/0236; H04W 88/06

(57) ABSTRACT

A duplication mode may allow a wireless transmit-receive unit (WTRU) and/or a user plane function (UPF) to duplicate traffic across multiple access networks (e.g., both 3GPP and non-3GPP access legs). The duplication mode may include a redundant steering mode with static duplication (e.g., static_K). The duplication mode may be associated with a duplication factor K. For example, K% of the protocol data units (PDUs) (e.g., K% of all the PDUs of a service data flow) that are transmitted/received over a primary access may be duplicated and/or transmitted/received over a secondary access. In one or more examples herein, the value of K may be determined, and/or which access is the primary access may be determined.

### CROSS-REFERENCE TO RELATED APPLICATIONS

The application claims the benefit of U.S. Provisional Application 63/411,411, filed Sep. 29, 2022, the contents of which are incorporated by reference in its entirety herein.

### BACKGROUND

Mobile communications using wireless communication continue to evolve. A fifth generation of mobile communication radio access technology (RAT) may be referred to as 5G new radio (NR). A previous (legacy) generation of mobile communication RAT may be, for example, fourth-generation (4G) long-term evolution (LTE). Wireless communication devices may establish communications with other devices and data networks, e.g., via an access network, such as a radio access network (RAN).

### SUMMARY

Systems, methods, and instrumentalities are disclosed herein for a duplication mode (e.g., a redundant steering mode). The duplication mode may allow a wireless transmit-receive unit (WTRU) and/or a user plane function (UPF) to duplicate traffic across multiple access networks (e.g., both 3GPP and non3GPP access legs). The duplication mode may include a redundant steering mode with static duplication (e.g., static_K).

A wireless transmit/receive unit (WTRU) or a user plane function (UPF) may determine whether to send duplicate protocol data unit(s) (PDU(s)), for example, based on a duplication factor value. The WTRU or UPF may receive configuration information associated with multi-access. The configuration information may indicate a primary access network, a duplication factor value (e.g., multiple duplication factor values, such as, for example, a first duplication factor value and a second duplication factor value), and/or a window size. The configuration information may comprise rules associated with access traffic steering switch and splitting (ATSSS) rules for a static redundant steering mode. The WTRU or UPF may determine a ratio of duplicated PDUs (e.g., on a per service data flow basis) during a duration of time (e.g., time window, rolling time window) associated with the window size, for example, based on a first number of bytes included in a first set of PDUs and a second number of bytes included in a second set of PDUs (e.g., the ratio is determined as a ratio of the second number of bytes included in the second set of PDUs to the first number of bytes included in the first set of PDUs). The first set of PDUs may be a set of PDUs that were transmitted via the primary access network during the duration of time. The second set of PDUs may be a first set of duplicated PDUs that were transmitted during the duration of time. The ratio of duplicated PDUs during the duration of time may be determined based on the rules associated with ATSSS. The WTRU or UPF may have a first PDU to transmit to a UPF or WTRU respectively. The WTRU or UPF may determine whether to send a duplicated PDU via a secondary access network, for example, based on the ratio of the duplicated PDUs during the duration of time and a selected duplication factor. The determination whether to send a duplicated PDU via the secondary access network may be based on one or more of the following: a duplication pattern, a duplication cycle, a priority of the first PDU, a mode associated with a second WTRU (e.g., power savings mode associated with the second WTRU), etc. The WTRU may send (e.g., via the primary access network) a first PDU. The WTRU may send a second PDU via the secondary access network, for example, based on the determination of whether to send the duplicated PDU via the secondary access. The second PDU may be the first PDU duplicated.

A UPF may be enabled to send duplicated PDUs to a WTRU. The UPF may determine a mode associated with the WTRU (e.g., power savings mode). The UPF may determine that the WTRU is in power savings mode. The UPF may determine to refrain from sending the duplicated PDU via the secondary access network to the WTRU, for example, based on the mode associated with the WTRU (e.g., based on the determination that the WTRU has a power savings mode enabled).

The WTRU or UPF may determine whether to duplicate a PDU based on a duplication factor and a priority value associated the first PDU. The WTRU or UPF may be indicated (e.g., via configuration information) a first priority threshold associated with a first duplication factor value, and a second priority threshold associated with a second duplication factor value. The WTRU may select a duplication factor value based on the priority associated the first of PDUs.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example WTRU with multiple accesses (e.g., simultaneous 3GPP and non-3GPP access).

FIG. 3 illustrates an example WTRU with multiple accesses (e.g., simultaneous 3GPP and non-3GPP access), which is different from the example illustrated in FIG. 2.

FIG. 4 illustrates an example redundant steering mode operation with static_K duplication.

FIG. 5 illustrates an example duplication factor over a rolling window.

FIG. 6 illustrates an example PDU duplication based on a bit pattern.

FIG. 7 illustrates an example PDU duplication based on a schedule.

FIG. 8 illustrates an example duplicate discard function for a WTRU.

### DETAILED DESCRIPTION

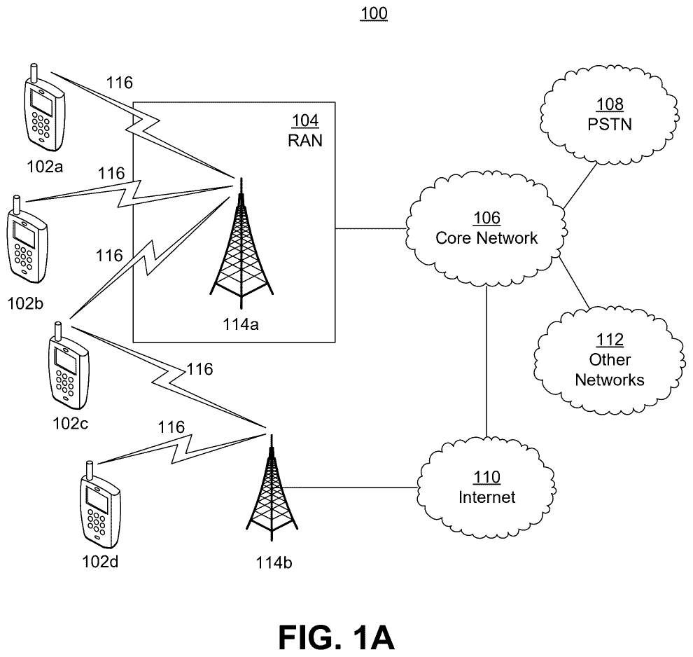

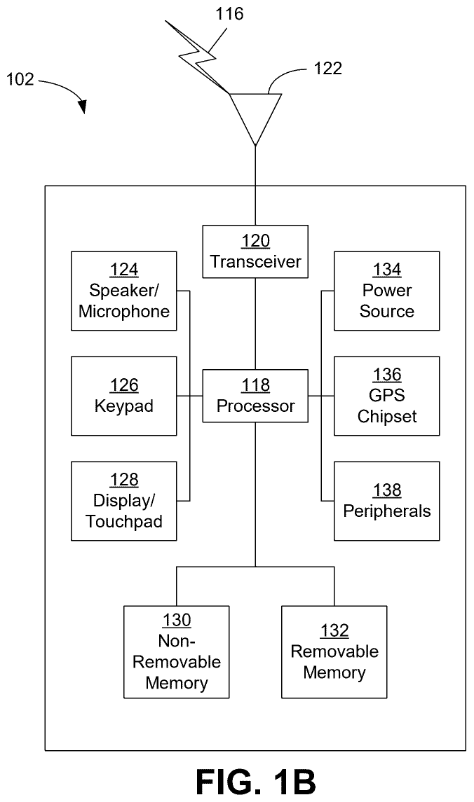

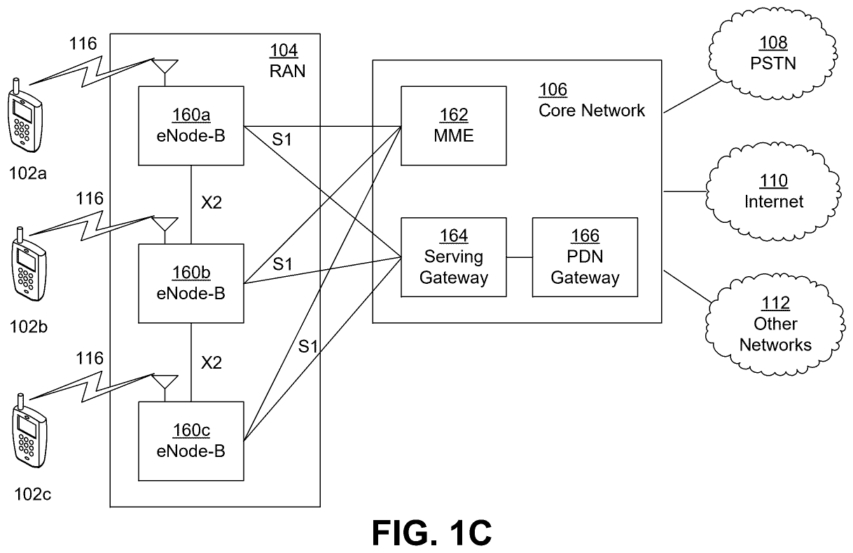

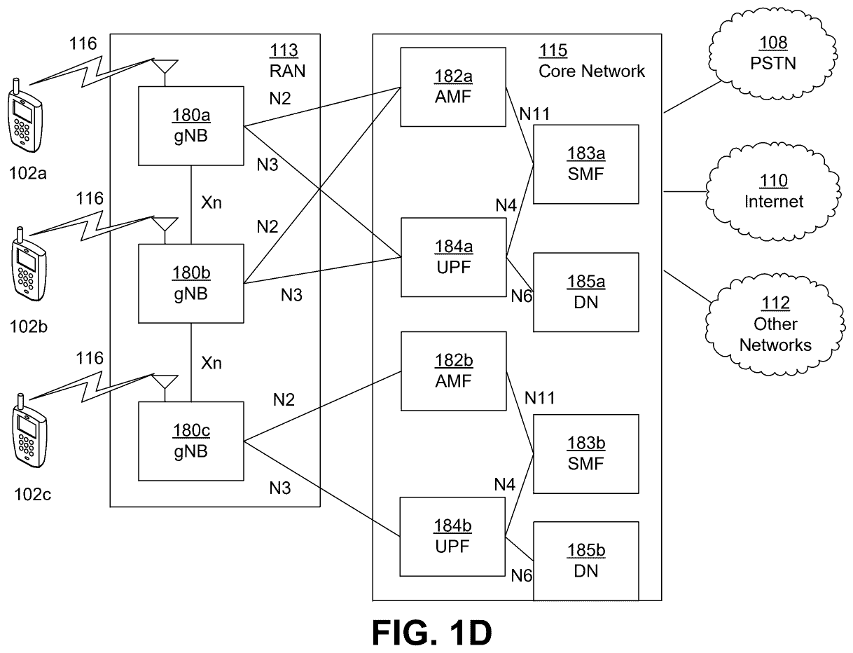

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR, etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements is depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 182 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be testing equipment. Direct RF coupling and/or wireless communications via RF circuitry (e.g., which may include one or more antennas) may be used by the emulation devices to transmit and/or receive data.

Systems, methods, and instrumentalities are disclosed herein for a duplication mode (e.g., a redundant steering mode). The duplication mode may allow a wireless transmit-receive unit (WTRU) and/or a user plane function (UPF) to duplicate traffic across multiple access networks (e.g., both 3GPP and non3GPP access legs). The duplication mode may include a redundant steering mode with static duplication (e.g., static_K).

A wireless transmit/receive unit (WTRU) or a user plane function (UPF) may determine whether to send duplicate protocol data unit(s) (PDU(s)), for example, based on a duplication factor value. The WTRU or UPF may receive configuration information associated with multi-access. The configuration information may indicate a primary access network, a duplication factor value (e.g., multiple duplication factor values, such as, for example, a first duplication factor value and a second duplication factor value), and/or a window size. The configuration information may comprise rules associated with access traffic steering switch and splitting (ATSSS) rules for a static redundant steering mode. The WTRU or UPF may determine a ratio of duplicated PDUs (e.g., on a per service data flow basis) during a duration of time (e.g., time window, rolling time window) associated with the window size, for example, based on a first number of bytes included in a first set of PDUs and a second number of bytes included in a second set of PDUs (e.g., the ratio is determined as a ratio of the second number of bytes included in the second set of PDUs to the first number of bytes included in the first set of PDUs). The first set of PDUs may be a set of PDUs that were transmitted via the primary access network during the duration of time. The second set of PDUs may be a first set of duplicated PDUs that were transmitted during the duration of time. The ratio of duplicated PDUs during the duration of time may be determined based on the rules associated with ATSSS. The WTRU or UPF may have a first PDU to transmit to a UPF or WTRU respectively. The WTRU or UPF may determine whether to send a duplicated PDU via a secondary access network, for example, based on the ratio of the duplicated PDUs during the duration of time and a selected duplication factor. The determination whether to send a duplicated PDU via the secondary access network may be based on one or more of the following: a duplication pattern, a duplication cycle, a priority of the first PDU, a mode associated with a second WTRU (e.g., power savings mode associated with the second WTRU), etc. The WTRU may send (e.g., via the primary access network) a first PDU. The WTRU may send a second PDU via the secondary access network, for example, based on the determination of whether to send the duplicated PDU via the secondary access. The second PDU may be the first PDU duplicated.

A UPF may be enabled to send duplicated PDUs to a WTRU. The UPF may determine a mode associated with the WTRU (e.g., power savings mode). The UPF may determine that the WTRU is in power savings mode. The UPF may determine to refrain from sending the duplicated PDU via the secondary access network to the WTRU, for example, based on the mode associated with the WTRU (e.g., based on the determination that the WTRU has a power savings mode enabled).

The WTRU or UPF may determine whether to duplicate a PDU based on a duplication factor and a priority value associated the first PDU. The WTRU or UPF may be indicated (e.g., via configuration information) a first priority threshold associated with a first duplication factor value, and a second priority threshold associated with a second duplication factor value. The WTRU may select a duplication factor value based on the priority associated the first of PDUs.

Access Traffic Steering, Switch and Splitting (ATSSS) may be provided.

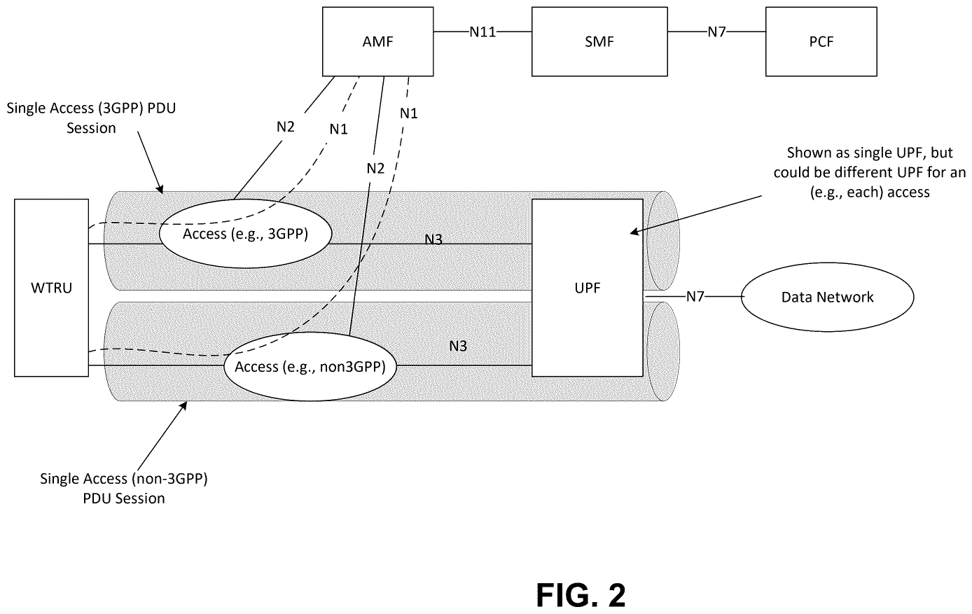

WTRUs may be capable of both 3GPP access and non-3GPP access. This capability may provide flexibility to network operators, for example, in determining which access to use for a service data flow. In some examples, a WTRU using both 3GPP access and non-3GPP access may establish (e.g., be required to establish) PDU sessions (e.g., independent single-access PDU sessions) over respective accesses (e.g., as shown in FIG. 2). FIG. 2 illustrates an example WTRU with multiple accesses (e.g., simultaneous 3GPP and non-3GPP access).

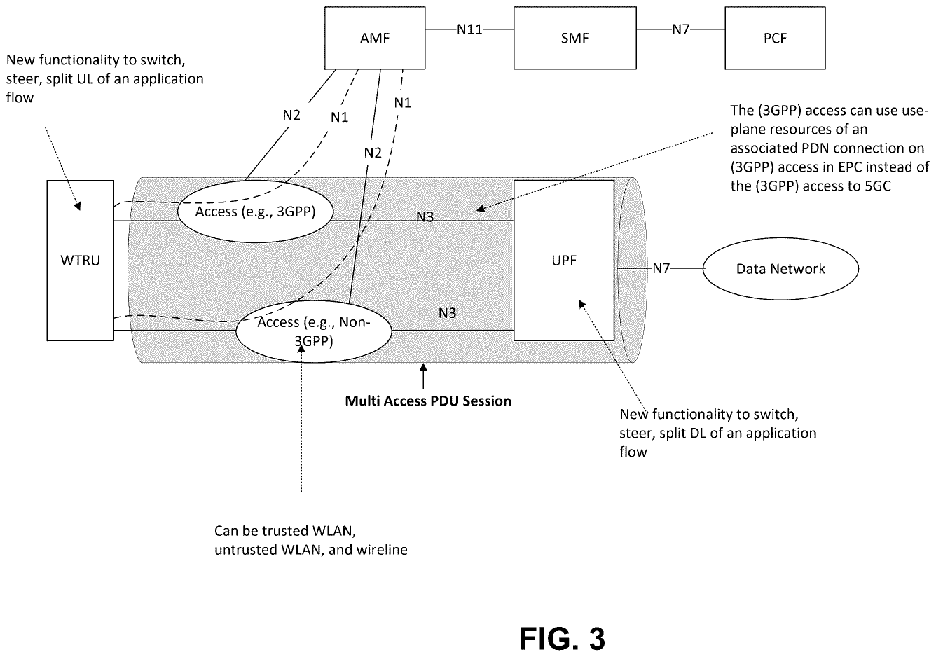

A multi-access PDU session may be used, for example, which may allow uplink and downlink traffic of a service data flow to be steered, switched, or split between accesses (e.g., as shown in FIG. 3), for example, to take advantage of the flexibility (e.g., provided by the WTRU capability to use both accesses (e.g., 3GPP access and non-3GPP access). A multi-access PDU session may include a PDU session whose traffic may be sent over 3GPP access, or over non-3GPP access, or over both accesses.

FIG. 3 illustrates an example WTRU with multiple accesses (e.g., simultaneous 3GPP and non-3GPP access), which may be different from the example illustrated in FIG. 2. The example in FIG. 3 may enable various steering functionalities. The example in FIG. 3 may enable one or more of access traffic steering, access traffic switching, or access traffic splitting. Access traffic steering may include selecting (e.g., a procedure that selects) an access network for a data flow (e.g., a new data flow) and may include transferring the traffic of this data flow over the selected access network. Access traffic steering may be applicable between accesses (e.g., 3GPP and non-3GPP accesses). Access traffic switching may include moving (e.g., a procedure that moves) the traffic (e.g., all traffic) of an ongoing data flow from one access network to another access network, for example, in a way that maintains the continuity of the data flow. Access traffic switching may be applicable between accesses (e.g., 3GPP and non-3GPP accesses). Access traffic splitting may include splitting (e.g., a procedure that splits) the traffic of a data flow across multiple access networks. Some traffic of the data flow may be transferred via one access and some other traffic of the same data flow may be transferred via another access, for example, if (e.g., when) traffic splitting may be applied to a data flow. Access traffic splitting may be applicable between 3GPP and non-3GPP accesses.

The steering functionality in an WTRU (e.g., ATSSS-capable WTRU) may steer, switch, and/or split PDU session traffic (e.g., MA PDU session traffic) across different access networks (e.g., 3GPP access and non-3GPP access). Multiple steering functionalities may be implemented. A high-layer steering functionality may be used, for example, which may operate above the IP layer. In examples, a (e.g., only one) high-layer steering functionality (e.g., MPTCP functionality) may be specified, which applies the Multipath Transmission Control Protocol (MPTCP) protocol (e.g., Internet Engineering Task Force (IETF)). This functionality may be applicable to (e.g., only applicable to) TCP traffic. A low-layer steering functionality may be used, for example, which may operate below the IP layer. In examples, one type of (e.g., only one type of) low-layer steering functionality (e.g., ATSSS Low-Layer functionality or ATSSS-LL functionality) may be defined. The ATSSS-LL functionality may be applicable to Ethernet and IP (e.g., the latter which may include TCP and UDP). The steering functionality may be a functionality (e.g., a new functionality) that is in both the WTRU and the UPF (e.g., the endpoints of a PDU session).

One or more steering functionalities herein may enable multiple steering modes. A steering mode may determine how the traffic of a matching service data flow may be distributed across 3GPP and non- 3GPP accesses. The steering modes may include one or more of active standby, smallest delay, load balancing, or priority-based steering mode.

The active standby mode may be used to steer traffic on an access (e.g., the active access) when this access is available, and to switch the traffic to the other access (e.g., the standby access) when the active access becomes unavailable.

A delay mode (e.g., smallest delay mode) may be used to steer traffic to an access. For example, a delay (e.g., which may be the smallest delay) may be used to steer traffic to the access that may (e.g., be determined to) have the smallest round-trip time (RTT). The WTRU and UPF may measure the RTT to determine which access has the lowest RTT. It may be used (e.g., only used) for the non-Guaranteed Bit Rate (GBR) Service Data Flow (SDF).

A load balancing mode may be used to split traffic across both accesses according to a percentage for how much traffic that is to be sent over access(es) (e.g., 3GPP access and over non-3GPP access). Load-Balancing may be applicable (e.g., only applicable) to non-GBR SDF.

A priority based steering mode may be used to steer the traffic (e.g., all the traffic matching a Policy Charging Control (PCC) rule to the high priority access, until this access is determined to be congested). In this case, the traffic may be sent also to the low priority access, e.g., the traffic may be split over the two accesses. It may be used (e.g., only used) for the non-GBR SDF.

For the load balancing steering mode, a steering mode Indicator may be used, for example, which may indicate that the WTRU may change the default steering parameters provided in the steering mode component and/or may adjust the traffic steering based on its own decisions. One (e.g., only one) of the following steering mode indicators may be provided: autonomous load-balance indicator; an assistance indicator (e.g., WTRU-assistance indicator).

When an autonomous load-balance indicator is provided, a WTRU may ignore the percentages in the steering mode component (e.g., the default percentages provided by the network) and/or may determine (e.g., autonomously determine) its own percentages for traffic splitting, for example, in a way that maximizes the aggregated bandwidth in the uplink direction.

The indicator may indicate (e.g., if/when a WTRU-assistance indicator is provided by the network) one or more of the following: the WTRU may decide how to distribute the Uplink (UL) traffic of the matching SDF based on the WTRU's internal state (e.g. when the WTRU may be in the internal state, e.g. lower battery level); the WTRU may inform the UPF how it has decided to distribute the UL traffic of the matching SDF; etc. In examples, the WTRU may distribute the UL traffic as indicated by the network (e.g., even though this indicator may be provided to the WTRU).

A threshold value may be used for the load balancing steering mode. A threshold value may be a value for Round-Trip Time (RTT) or a value for Packet Loss Rate. The threshold values may be applicable to both accesses and/or may be applied by the WTRU and/or the UPF. The WTRU and/or UPF may stop sending traffic on an access (e.g., the first access network), or may continue sending traffic on this access but reduce the traffic on this access (e.g., by an implementation specific amount) and may send the amount of reduced traffic on the other access (e.g., a second access network). For example, if (e.g., when) at least one measured parameter (e.g., RTT or Packet Loss Rate) on an access (e.g., a first access network) exceeds the provided threshold value. The WTRU and UPF may apply the split percentages, for example, if (e.g., when) the (e.g., all) measured parameters (e.g., RTT and Packet Loss Rate) for both accesses do not exceed the provided threshold values.

A threshold value may be used for the priority based steering mode (e.g., SMSteering Mode). A threshold value may be a value for RTT or a value for PLRPacket Loss Rate. The threshold values may be applicable to both accesses and/or may be applied by the WTRU and/or the UPF. The threshold value(s) may be considered by WTRU and/or the UPF to determine when an access becomes congested. For example, when a measured parameter (e.g., RTT or Packet Loss Rate) on an access (e.g., a first access network) exceeds the provided threshold value, the WTRU and/or the UPF may consider this access (e.g., the first access network) as congested and send the traffic also to the low priority access.

Rules may be used at the WTRU and the UPF, for example, to enable the steering modes for a steering functionality (e.g., each of the steering functionalities). For example, the rules may be generated by a Session Management Function (SMF), based on information known to the Policy Control Function (PCF), and sent to the WTRU (e.g., ATSSS rules) for determining switching functionality and/or switching mode to use for UL traffic, and may be sent to the UPF (e.g., N4 rules) for determining switching functionality and/or switching mode to use for downlink (DL) traffic.

A performance management function (PMF) protocol may be used, for example, to support one or more of the steering modes herein, at WTRU and UPF to make the measurements for the switching mode decisions (e.g., Round Trip Time Measurements, Access Availability/Unavailability Report, and/or packet loss rate).

A different redundant steering mode may be used (e.g., where the traffic may be duplicated over both accesses), for example, to better meet the requirements of the service data flows. One or more options for redundant steering mode may be available. These options may deal with dynamicity of the duplication and/or may be categorized as follows: static_100 (100% redundancy); static_K (K% redundancy); dynamic.

For static_100 (100% redundancy), the duplication decision may be per flow, and the packets (e.g., all packets) of the flow may be duplicated across both accesses.

For static_K (K% redundancy): the duplication decision may be per flow, but K% (e.g., only K%) of the packets of the flow may be duplicated across both accesses. The network may tell the WTRU and UPF which of the accesses may be the primary access (e.g., over which all packets may be transmitted) and which may be the secondary access (e.g., over which K% of packets may be duplicated). The value of K may be provided by the network to the WTRU and UPF.

For dynamics, the duplication decision may be per packet of a flow, and the decision may be based on measurements and criteria. The measurement and/or criteria may vary from one example to another. In some examples herein, traffic may not be duplicated when it may not be needed.

A duplication mode (e.g., a redundant steering mode) may apply to the WTRU and UPF transmissions. For the static_K case, the traffic (e.g., all traffic) may be sent over a primary leg, and K% of the traffic may be duplicated over the secondary leg. In one or more examples herein, the network may determine the value of K and/or the role of the two legs (e.g., which leg is the primary and which leg is the secondary leg). These decisions may or may not be the same for the WTRU to UPF transmissions (uplink) and the UPF to WTRU transmissions (downlink). For example, uplink and downlink may have different K values. The WTRU (or UPF) may determine which packets are to be duplicated over the secondary access to achieve the K% duplication. The network may change the value of K. If the network changes the value of K, a trigger may be used to trigger the change in value and/or the procedure to implement such a change. The network may interchange the primary and secondary access. A trigger may be used to trigger a change in the roles of primary access and secondary access and/or the procedure to implement such a role change, for example, if the network interchanges the primary and secondary access. A receiving entity (e.g., the WTRU or the UPF) may save power, for example, if (e.g., when) the duplication may be not necessary. The receiving entity may not have prior knowledge as to which packets are duplicated or not.

This decision may be made by the transmitting entity. In some examples, the receiving entity may know that the service data flow parameters (e.g., requirements) are being met by an access (e.g., a single access). The operation of the receiving entity may be optimized in such cases.

A duplication mode (e.g., a redundant steering mode) may allow a WTRU and/or an UPF to duplicate traffic across access legs (e.g., both 3GPP and non-3GPP access legs). A type of redundant steering mode may include static_K. In a redundant steering mode with static duplication, the PDUs (e.g., all PDUs) may be transmitted over a primary access, and K% of the PDUs may be duplicated over a secondary access. In one or more examples herein, the value of K may be determined, and/or which access is the primary access may be determined.

Systems, methods, and instrumentalities are disclosed herein for a duplication mode (e.g., a redundant steering mode). The duplication mode may allow a wireless transmit-receive unit (WTRU) and/or a user plane function (UPF) to duplicate traffic across multiple access networks (e.g., both 3GPP and non-3GPP access legs). The duplication mode may include a redundant steering mode with static duplication (e.g., static_K).

A duplication mode may be associated with a duplication factor K. For example, K% of the protocol data units (PDUs) (e.g., K% of all the PDUs of a service data flow) that are transmitted/received over a primary access may be duplicated and/or transmitted/received over a secondary access. In one or more examples herein, the value of K may be determined, and/or which access is the primary access may be determined.

A network may determine an initial value of a duplication factor K and/or an initial primary access to use. For example, a network device may determine whether to enable a duplication mode. The network device may determine a duplication factor based on a determination to enable the duplication mode. The duplication factor may indicate the number of PDU packets that are to be duplicated among the PDU packets associated with a first access network. The network device may receive the duplicated PDU packets via the second access network and receive the PDU packets associated with the first access network via the first access network. The first access network may be a primary access network, while the second access network may be a secondary access network. The network may send the duplication factor.

A WTRU and/or a UPF may select the K% of PDUs of a service data flow, to be duplicated. For example, the WTRU may receive configuration information indicating a duplication mode and a duplication factor associated with the duplication mode. The WTRU may obtain a PDU packet and determine whether to duplicate the PDU packet based on the configuration information. The WTRU may send the PDU packet based on the determination of whether to duplicate the PDU packet.

A receiving entity (e.g., the WTRU) may reduce monitoring, for example, when the receiving entity determines that service data flow parameters (e.g., requirements) are met by an access (e.g., a single access). For example, the WTRU may terminate an attempt to decode a duplicated PDU packet on the second access network based on the determination that the PDU packet received via the first access network may be sufficient to meet service data flow parameters (e.g., requirements).

The value of the duplication factor K and/or a designation of a primary access may be subject to change.

In one or more examples herein, the term “service data flow (SDF)” may be used to describe traffic from an application that is to be impacted by a steering mode. SDF may be identified by one or more of an IP 5-tuple, a specific application ID, or any identifier that may identify the flow of an application.

A WTRU and UPF may be configured with a multi-access PDU session. The WTRU and/or the UPF may transmit PDUs over a path (e.g., 3GPP path and/or a non-3GPP path). In one or more examples herein, the terms “access path” or “access leg” are used interchangeably.

A duplication mode (e.g., a redundant steering mode) may allow PDUs to be duplicated and transmitted over multiple accesses (e.g., 3GPP and non-3GPP). In one or more examples herein, the term static_K redundant steering mode and static_K duplication are used interchangeably, which may refer to a steering mode where the traffic (e.g., all traffic) is sent on the primary access and K% of the traffic is duplicated over the secondary access.

Duplication may apply to both WTRU to UPF (uplink) transmissions and UPF to WTRU (downlink) transmissions. For an uplink transmission, the transmitting entity may be the WTRU, and the receiving entity may be the UPF. For a downlink transmission, the transmitting entity may be the UPF, and the receiving entity may be the WTRU. Herein, the term transmitting entity may refer to both a WTRU for uplink transmissions and an UPF for downlink transmissions. The term receiving entity may refer to both a WTRU for downlink transmissions and an UPF for uplink transmissions.

ATSSS-capable WTRUs and networks (e.g., such as 5G Core (5GC) networks) may use the procedures in one or more examples herein (e.g., the procedures may be applied only by ATSSS-capable WTRUs and 5GC networks). A WTRU may determine whether ATSSS is supported by the network based on a Multi-Access (MA) PDU session support indicator (e.g., provided by the AMF during the registration procedure(s)). The network may decide to enable or disable a redundant steering mode, for example, if both the WTRU and the network (e.g., such as 5GC) are ATSSS capable. The network may decide whether to employ static_K duplication and/or determine the value of K, for example, if redundant steering mode is enabled.

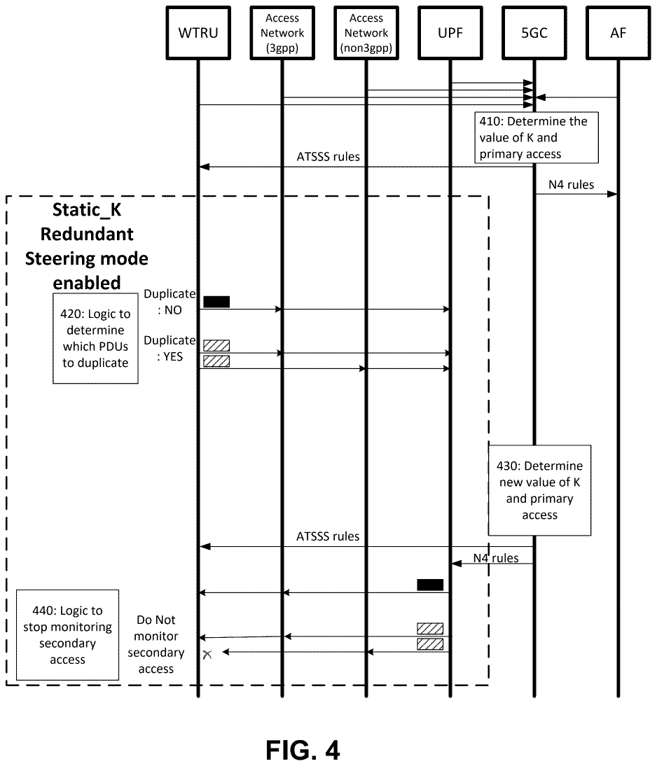

FIG. 4 illustrates an example redundant steering mode operation with static_K duplication.

At 410, the network may decide (e.g., must decide) on the value of K and/or the primary access to use. The network may make this decision based on inputs from various entities (e.g., AF, UPF, WTRU, etc.). The network may then provide a static_K configuration to both the WTRU and UPF. When the configuration is received by the WTRU and UPF, static_K duplication may be enabled. At 420, the WTRU may determine which PDUs to duplicate to maintain the K% duplication factor. At 430, (e.g., during operation), the network may decide to change the value of K and/or the primary access to use. A different configuration (e.g., a new configuration) may be provided for the WTRU and UPF. At 440, the WTRU may decide to stop monitoring the secondary access, for example, if the WTRU deems that reception of the duplicated PDUs is not needed.

Static_K redundant steering mode may be used in one or more examples herein.

The network may determine the value of K and/or the role of the two legs.

The network may provide the value of K and/or the primary access to both the WTRU and the UPF. This information may be provided (e.g. in the ATSSS rules to the WTRU and/or in the N4 rules to the UPF). The network may use one or more of the following to determine K and/or the primary access.

The value of K and/or the primary access may be provided by an Application Function (AF). The AF may provide the service data flow parameters (e.g., requirements) and an indication that the service data flow may use a static_K redundant steering mode. The AF may provide the value of K and/or a preference of which access to use for the primary leg. This information may be provided through the Nnef_TrafficInfluence_Create, Nnef_TrafficInfluence_Update, Nnef_AFsession WithQoS_Create, or Nnef_AfsessionWithQoS_Update services. The AF may provide separate K and/primary access information to the WTRU and the UPF.

The WTRU may provide the value of K and/or the primary access during PDU Session establishment or PDU session modification. The WTRU may suggest a value of K. For example, the WTRU may determine that it may duplicate (e.g., only duplicate) K% of the traffic. The determination of the value K may be based on WTRU measurements. A WTRU may determine that access (e.g., non-3GPP access) is loaded to an extent (e.g., greater than a threshold) and may limit duplication so as not to increase this load. In some examples, the determination of the value K may be based on other criteria. A WTRU may decide to have a low K to control the power consumption, for example, if the WTRU has some power issue. The WTRU may suggest a primary access. The suggestion of the primary access may be based on WTRU measurements. For example, the WTRU may prefer to use an access (e.g., 3GPP access) as the primary access because it may have a better packet loss rate (PLR) compared to a different access path (e.g., the non 3GPP path). The WTRU may receive configuration information indicating (e.g., be (pre)-configured with) the value of K and/or the primary access. For example, a WTRU may use a K of 50% and an access (e.g., 3GPP access) as the primary access, as preconfigured. In some examples, the WTRU may be (pre) configured with the value of K and/or primary access based on the application name or type of application. Some applications may request (e.g., require) a higher redundancy and/or throughput. The WTRU may have a (pre)configured higher value of K for the applications that request (e.g., require) a higher redundancy and/or throughput.

The network may determine information through one or more of measurements made at the WTRU, measurements made at the UPF, measurements made in the NG-RAN nodes, measurements made in the (e.g., non-3GPP) Interworking Function (N3IWF) nodes, measurements made in the Trusted Non-3GPP Gateway Function (TNGF) nodes and/or Quality of Service (QoS) parameters (e.g., requirements) of the SDF. In examples, (e.g., some or all of) these measurements may be provided to the NWDAF, which may determine the value of K and/or the primary access based on some or all of these measurements. The WTRU measurements may be sent (e.g., over control plane signaling) to the Network Data Analytics Function (NWDAF), or they may be sent to the UPF which may then forward them to the NWDAF, or they may be sent to the AMF which then forwards them to the NWDAF. The NWDAF may determine a K value and primary access for the WTRU and/or the UPF.

The WTRU and UPF may use the Performance Management Function (PMF) protocol to negotiate the value of K and/or the primary access. In such a case, the PDU session may be established (e.g., initially) with 100% duplication. The establishment of the PDU session may trigger the WTRU and UPF to exchange PMF messages. The WTRU may send a request message (e.g., a performance management function protocol (PMFP) STATIC K request message), notifying the UPF about the proposed value of K and/or the primary access. The UPF may respond with a response message (e.g., a PMFP STATIC K response message) with the selected K and/or the primary access. In some examples, the UPF may initiate the exchange (e.g., by sending a PMFP STATIC K request message), and/or the WTRU may respond (e.g., by sending the PMFP STATIC K response message) with the selected K and/or the primary access.

In some examples, a WTRU may provide the network with a proposed K and/or a proposed primary access, and the network may determine a selected K and/or a selected primary access, for example, based on this information along with measurement information.

A WTRU and/or a UPF may determine which packets to duplicate.

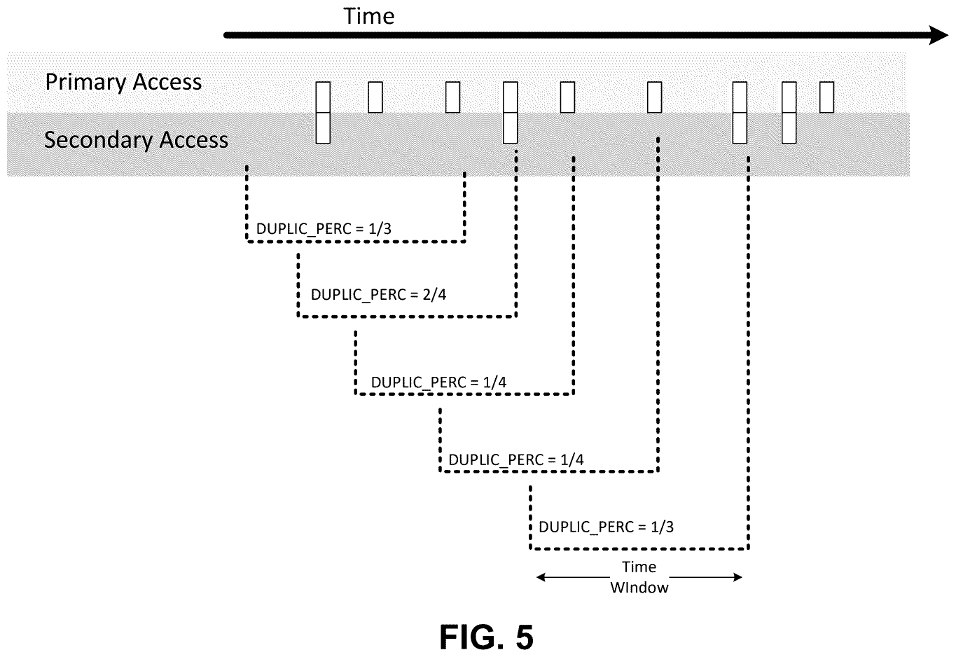

The WTRU and/or UPF may track whether they are adhering to the duplication factor of K% (e.g., as a first step for a procedure for determining which packets to duplicate). The WTRU and/or the UPF may use a duration of time (e.g., form of a rolling window of size T_window, for example), for example, to track whether they are adhering to the duplication factor of K%. The WTRU (and UPF) may calculate/estimate/measure a duplication percentage (DUPLIC_PERC) over this duration of time (e.g., rolling window, e.g., as shown in FIG. 5). FIG. 5 illustrates an example duplication factor over a rolling window. This duplication percentage may be calculated/estimated/measured, for example, based on the ratio of the number of PDUs duplicated to the total number of PDUs transmitted over this window (e.g., as shown in FIG. 5). The WTRU and UPF may update the duration of time (e.g., a rolling window), for example, every T_update msec or for every new PDU transmission. The example in FIG. 5 may show a rolling window updated for (e.g., new) PDU transmissions. The WTRU and/or the UPF may store information (e.g., in a buffer) for a transmitted PDU (e.g., each transmitted PDU), for example, to perform the calculation. The information may include, for example, the time of PDU transmission and/or whether the PDU was duplicated or not. After a PDU transmission at time T1, the WTRU and UPF may determine the total number the PDUs transmitted in interval [T1−T_window, T1] (PDU_Tot), as well as the total number of PDUs duplicated in interval [T1−T_widow, T1] (PDU_Duplic). The estimate of DUPLIC_PERC=PDU_Duplic/PDU_Tot. In some examples, as the size of the PDUs differs, the duplication percentage may be based on the ratio of the number of bytes of the duplicated PDUs (e.g., all duplicated PDUs) to the total number of bytes of the transmitted PDUs (e.g., all transmitted PDUs). The rolling window size may be provided to the WTRU with the ATSSS rules, and/or to the UPF with the N4 rules.

The WTRU and/or the UPF may duplicate PDUs according to the respective rules (e.g., sending all PDUs over the primary access, and duplicating K % of the PDUs over the secondary access), for example, if the WTRU receives the ATSSS rules and the UPF receives the N4 rules. For a PDU (e.g., each PDU), the WTRU (and UPF) may decide if this PDU is to be transmitted over the secondary access. One or more examples herein may provide how the WTRU and/or UPF makes this decision, for example to increase efficiency (e.g., in terms of power usage and resource usage). In some examples, the decision may be made randomly. In one or more examples herein, a WTRU/UPF may calculate/estimate/measure the DUPLIC_PERC over a duration of time (e.g., time window). The algorithms in one or more examples herein may enable the WTRU/UPF to determine which PDU to duplicate or not, for example, in a way in which DUPLIC_PERC estimation/calculation/measurement stays close to K. One or more of the following may be used to determine whether to duplicate a PDU.

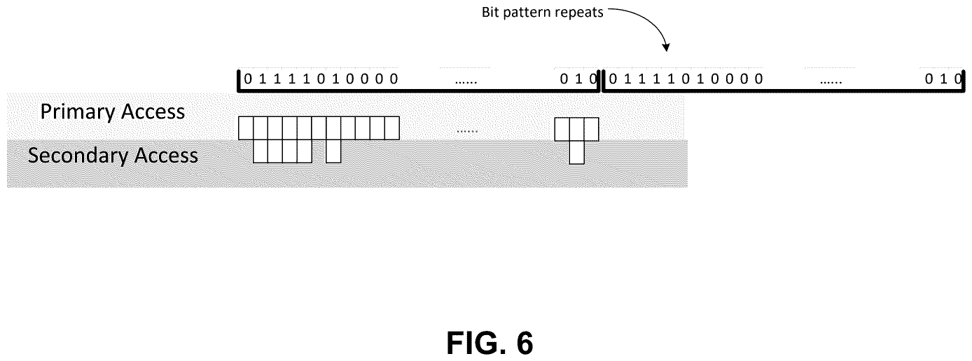

The WTRU and/or the UPF may be provided with a bit pattern to implement the K% (e.g., as shown in FIG. 6), for example, to determine whether to duplicate a PDU. FIG. 6 illustrates an example PDU duplication based on a bit pattern. For example, a 100-bit pattern may be configured, with K bits set to ‘1’. A bit (e.g., every bit) may correspond to a PDU transmission. When the corresponding bit is a first value (e.g., ‘0’), the WTRU (or UPF) may transmit (e.g., only transmit) the PDU over the primary access. When the corresponding bit is a second value (e.g., ‘1’), the WTRU (or UPF) may duplicate the PDU over both accesses. The network may perform one or more of the following: stagger the duplicate transmissions over the secondary access; configure the bit pattern to favor duplicate transmissions over the secondary access, for example, if (e.g., when) the secondary access is less loaded (e.g., than a certain value or than the primary access); configure a bit pattern to favor a duplication of priority (e.g., higher priority) packets, for example, in cases where the network knows the traffic pattern; etc. The bit pattern may be provided to the WTRU (e.g., with the ATSSS rules) and/or to the UPF (e.g., with the N4 rules).

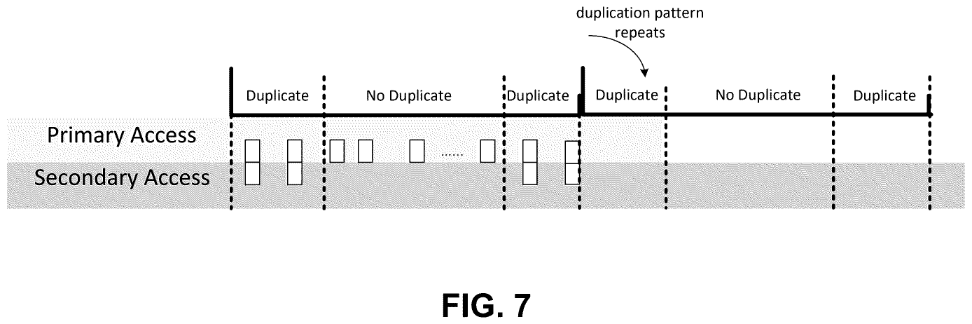

The WTRU and/or the UPF may be provided with a schedule of time periods where the WTRU (and UPF) duplicate PDUs, for example, to determine whether to duplicate a PDU. The schedule may be such that a duplication is configured for K% of the time (e.g., as shown in FIG. 7). FIG. 7 illustrates an example PDU duplication based on a schedule. During the time periods marked as “Duplicate,” the WTRU (or UPF) may duplicate PDUs over the secondary access. During the times marked as “NoDuplicate,” traffic may be sent over the primary access (e.g., all traffic may be sent only over the primary access). The network may stagger the duplicate transmissions over the secondary access. In some examples, the network may send (e.g., configure) the schedule to favor duplicate transmissions over the secondary access, for example, if (e.g., when) the secondary access may be less loaded (e.g., than a certain value or than the primary access). The schedule may be provided to the WTRU (e.g., with the ATSSS rules) and/or to the UPF (e.g., with the N4 rules).

The WTRU and/or the UPF may use a rule based on the type of packets or the priority of the PDUs, for example, to determine whether to duplicate a PDU. A WTRU may receive configuration information indicating (e.g., be configured to) duplicate the PDUs (e.g., all PDUs) of a high priority, or of a priority higher than a threshold. The priority of the PDU may be determined and/or embedded in the PDU header. The priority of the PDU may be indicated by a Differentiated Services Code Point (DSCP) value in the IP header. A PDU with the DSCP value within a set of DSCP values (e.g., DUPLIC_SET) may be duplicated (e.g., any PDU with DSCP value within a set of DSCP values (e.g., DUPLIC_SET) is to be duplicated). In some examples, the PDU may be part of a PDU Set. The PDU set may have a priority. The WTRU (or UPF) may duplicate the PDUs (e.g., all PDUs) in a PDU Set with a priority higher than a threshold (e.g., DUPLIC_THRESH). The DUPLIC_THRESH or DUPLIC_SET may be provided to the WTRU (e.g., with the ATSSS rules) and/or to the UPF (e.g., with the N4 rules).

To determine whether to duplicate a PDU, the WTRU and/or the UPF may use a rule, for example, based on the application that generates the PDU if the static_K redundant steering mode is applied per QoS flow or per PDU session.

The WTRU and UPF may use a rule based on the calculated duplication percentage, for example, to determine whether to duplicate a PDU. The WTRU or UPF may determine that (e.g., based on an implication) not enough duplication has been performed (e.g., has not duplicated enough) for a duration of time (e.g., current rolling window), for example, if the duplication percentage is such that DUPLIC_PERC<K. The next PDU may be duplicated to increase the duplication percentage. If the duplication percentage is such that DUPLIC_PERC>K, then this may imply that for the current rolling window, the WTRU (or UPF) have duplicated too many PDUs. The next PDU may be refrained from being duplicated (e.g., duplication may be skipped for the next PDU, not be duplicated) to decrease the duplication percentage.

In examples, the WTRU and/or the UPF may randomly duplicate PDUs over a duration of time (e.g., rolling window) to maintain/have a duplication factor close to K%. The WTRU and/or the UPF may switch, for example, (e.g., based on a triggering event) from randomly duplicating PDUs over a rolling window to selectively duplicating PDUs. The WTRU or UPF may start selectively duplicating PDUs (e.g., favoring duplication of high priority packets) based on the triggering event. Examples of the triggering event may include one or more of the following: the WTRU or UPF may have taken measurements (e.g., packet loss rate per access, delay per access, load per access) on the accesses and determined that duplication is to favor high priority PDUs; a user may request that duplication favor high priority PDUs; an application may request that duplication favor high priority PDUs.

In some examples, the WTRU and/or the UPF may determine the priority of a PDU (e.g., using DSCP, or other priority markers). The WTRU and/or UPF may receive configuration information indicating (e.g., be configured with) a target duplication (e.g., a target duplication different for each of the different priorities). The WTRU (or UPF) may duplicate PDUs, for example, according to their priority and target duplication factors (e.g., if the duplication factor over the rolling window is less than K). For an example with 2 priorities, a configuration may indicate and/or include P_1 as a high priority with duplication factor DF_1 at 100% and/or P_2 as a low priority with DF_2 at L% (with L<K). The PDUs (e.g., all PDUs) of priority P_1 may be duplicated (100%) and L% of PDUs (only L% of PDUs) of priority P_2 may be duplicated, for example, if the duplication factor over the rolling window is less than K. In an example with 3 priorities, the configuration may indicate and/or include one or more of: a P_1 as high priority with DF_1 at 100%; a P_2 as medium priority with DF_2 at L% (with L<K); and a P_3 as low priority with DF_3 at 0%. If the duplication factor over the rolling window is less than K, the PDUs (e.g., all PDUs) of priority P_1 may be duplicated (100%), L% of PDUs a (e.g., only) L% of PDUs) of priority P_2 may be duplicated, and PDUs of priority P_3 may not be duplicated.

In some examples, the trigger to have the WTRU and/or UPF duplicate PDUs according to the target duplication factors may differ from that used for the example above. The WTRU and/or UPF may keep a rolling count/estimation (COUNT_i) of a cumulative PDU size over the duration of time (e.g., time window), for a (e.g., each) observed priority (e.g., using one or more of DSCP, PDU set importance/priority, or other priority markers). A rolling count/estimation of cumulative PDU size over the duration of time (e.g., time window) may be kept by the WTRU (COUNT). This rolling count/estimation may help determine the duplication factor (DF_i) per priority level (P_i). The PDUs (e.g., all PDUs) with priority P_i may be duplicated, for example, if DF_i is 100%. The PDUs (e.g., all PDUs) with priority P_i may not be duplicated, for example, if DF_i is 0%. PDUs with priority P_i may be duplicated with a L% rate (e.g., using the example described herein, where the WTRU and the UPF may determine whether to duplicate a PDU using a rule based on the calculated duplication percentage), for example, if DF_i is L%. A different priority (e.g., each of the different priorities where, e.g., P_1 is the highest priority) may be assigned a target duplication factor (DF_i), using one or more of the following considerations. For example, the notation sum(j) may be used to designate the sum of all COUNT_i for i ranging from 1 to j. For each j: if sum(j) is lower than COUNT*K%, then DF_j may be set to 100%; if sum(j−1) is lower than COUNT*K%, and sum(j) is larger than COUNT*K%, then DF_j may be set to L%, where sum(j−1)+COUNT_j*L%=COUNT*K%; if both sum(j−1) and sum(j) are larger than COUNT*K%, then DF_j may be set to 0. For an example with 2 priorities, a configuration may indicate and/or include: P_1 as a high priority with DF_1 at 100%; P_2 as a low priority with DF_2 at L% (with L<K); L may be calculated based on the rolling counts/estimations, e.g. using: COUNT_1+COUNT_2*L%=(COUNT_1+COUNT_2)*K%. The PDUs (e.g., all PDUs) of priority P_1 may be duplicated (e.g., 100%) and L% (e.g., only L%) of PDUs of priority P_2 may be duplicated, for example, if the duplication factor for priority level 1 over the rolling window is less than K. For an example with 3 priorities, a configuration may indicate and/or include: P_1 as a high priority with DF_1 at 100%; P_2 as a medium priority with DF_2 at L% (with L<K); P_3 as a low priority with DF_3 at 0%; L may be calculated based on the rolling counts/estimations, e.g. using: COUNT_1+COUNT_2*L%=(COUNT_1+COUNT_2+COUNT_3)*K%. The PDUs (e.g., all PDUs) of priority P_1 may be duplicated (e.g., 100%), L% (e.g., only L%) of PDUs of priority P_2 may be duplicated, and PDUs of P_3 may be refrained from being duplicated (e.g., not be duplicated), for example, if the duplication factor for priority level 1 over the rolling window is less than K.

In one or more examples herein, the WTRU and/or the UPF may exceed the (e.g., configured) duplication factor of K%. For example, a DUPLIC_THRESH may be set at a value (e.g., that is low) and the WTRU (or UPF) may duplicate most of the PDUs, thereby exceeding the scaling factor of K%. In an example, the WTRU and//or UPF may cap the duplication at K%.

In one or more examples herein, the WTRU and/or UPF may meet the duplication factor of K%. For example, a DUPLIC_THRESH may be set at a value (e.g., that is high) and the WTRU and/or UPF may duplicate (e.g., only duplicate) M% of the traffic (e.g., with M<K). In such cases, the WTRU and/or UPF may use some other mechanism to make the duplication decision for non-prioritized PDUs. For example, the WTRU and/or UPF may randomly duplicate PDUs so that the overall duplication factor approaches K%. For example, the WTRU and/or UPF may duplicate a random percentage of the traffic so that the overall duplication factor approaches K%.

The value of K may be changed.

The network may change the value of K. If the network changes the value of K, this may be done by updating the ATSSS rules to the WTRU and/or the N4 rules to the UPF. Triggers for the change in value of K may include one or more of the following: a user preference; an application preference; the WTRU (or UPF) may take measurements on both accesses and determine that the current value of K is inappropriate; measurements and/or monitored events.

Triggers for the change in value of K may include a user preference. A user may use a graphical user interface to request that the WTRU use a different value of K. For example, a user may be using a home WiFi access point and/or may want to limit the use of the (e.g., 3GPP) access. The user may indicate changing the value K to a lower value.

Triggers for the change in value of K may include an application preference. An application may use (e.g., require) more redundancy for a service data flow or for high priority PDU sets within a service data flow. The application may request that the WTRU increase the value of K.

Triggers for the change in value of K may include a scenario where the WTRU and/or UPF may take measurements on both accesses and determine that the current value of K is inappropriate. For example, the (e.g., non-3GPP) network may be loaded to an extent (e.g., greater than a threshold that indicates heavy loading). Duplication over the network may not be useful (e.g., as it is unlikely to meet the service data flow requirements). The WTRU and/or the UPF may use one or more of the following measurements to make the determination that the current value of K is inappropriate: a packet loss rate, a delay, the variability of delay, or a load.

The measurements may include a packet loss rate (e.g., the rate of PDU packet loss for an (e.g., a) access network). A separate measure may be made for uplink transmissions and downlink transmissions.

The measurements may include a delay (e.g., the delay for an (e.g., each) access network). This may be a round-trip delay for an (e.g., each) access network or a one-way delay for an (e.g., a) access network (e.g., a delay from the WTRU to the UPF and/or a delay from the UPF to the WTRU). A separate measurement may be made for uplink transmissions and downlink transmissions. The delay may be an average (e.g., mean) of the measured round-trip delays for the respective access networks or the average (e.g., mean) of the measured one-way delays for the respective access networks.

The measurements may include the variability of delay (e.g., a measure of the variability of the packet transmissions on respective access networks). This may be the variability of the round-trip delays for respective access networks or of the one-way delays for respective access networks. A separate measure may be made for uplink transmissions and downlink transmissions. The variability measure may be one or multiple of: a statistical variance of the delays, a statistical standard deviation of the delays, a median of the delays, the k-th percentile of the delays, the maximum delay observed, the minimum delay observed, etc.

The measurements may include a load (e.g., a measure of the load on an (e.g., each) access network). It may be a measure of the over-the-air load, the transport network load (e.g., the load in core network on the N3/N9 interface to the UPF), or a combination of the over-the-air load and the transport network load.

The network may trigger a change of K based on measurements and/or monitored events. The network may detect an overload event on the primary access or the secondary access (e.g., the 3GPP leg or non-3GPP leg). The network may trigger a change in the value of K, for example, based on a detected overload event. For example, the load on an I-UPF (e.g., one of the I-UPFs) along one of the legs may cross a threshold. In some examples, the SMF may (e.g., decide to) reclaim network resources from the WTRU or the UPF, for example, by triggering a change in K. The network may (e.g., decide to) add or remove an I-UPF along one of the legs. This may trigger the network to change the value of K.

The primary access may be changed.

The network may change the roles of primary access and secondary access. If the network changes the roles of primary access and secondary access, this may be done by updating the ATSSS rules to the WTRU and/or the N4 rules to the UPF. Triggers for the change in the primary access may include one or more of the following: a user preference; a location; a property of the non-3GPP network; the WTRU (or UPF) may take measurements on both accesses and determine that the current designation of the primary access is inappropriate; measurements and/or monitored events.

Triggers for a change in primary access may include a user preference. A user may use or send a user interface request to indicate that the WTRU uses a different primary access. For example, a user may be using a home WiFi access point and may want to change the primary access (e.g., to non3GPP).

Triggers for the change in primary access may include a location. For example, a WTRU may be close to a home WiFi network. In such a case, the WTRU may prefer to use a specific network (e.g., the non-3GPP network).

Triggers for the change in primary access may include a property of the access network (e.g., non-3GPP access network). For example, this may be based on whether the access (e.g., non3GPP access) is trusted or untrusted, whether the WiFi access point is public or non-public, whether the WiFi access point supports some radio features, etc. For example, it may be preferable to not use a public WiFi access point as a primary access.

Triggers for the change in primary access may include a scenario where a WTRU and/or UPF takes measurements on both accesses and determines that the current primary access is inappropriate. The WTRU and/or UPF may select the access (e.g., the access which best meets the requirements of the service data flow) based on these measurements. The WTRU and/or UPF may use one or more of the following measurements to make this determination: a packet loss rate, a delay, a variability of delay, or a load.

The measurements may include a packet loss rate (e.g., the rate of PDU packet loss for an (e.g., each) access network). A separate measure may be made for uplink transmissions and downlink transmissions. The primary access may be chosen as the access with the lower packet loss rate (PLR).

The measurements may include a delay (e.g., the delay for an (e.g., each) access network). This may be the round-trip delay for an (e.g., each) access network or the one-way delay for an (e.g., each) access network (e.g., a delay from the WTRU to the UPF and/or a delay from the UPF to the WTRU). A separate measure may be made for uplink transmissions and downlink transmissions. The delay may be an average (e.g., mean) of the measured round-trip delays for respective access networks (e.g., each access network) or the one-way delay for respective access networks (e.g., each access network). The primary access may be chosen as the access with the lower delay.

The measurements may include a variability of delay. This may be a measure of the variability of the packet transmissions on respective access networks (e.g., each access network). This may be the variability of the round-trip delays for respective access networks (e.g., each access network) or the one-way delays for respective access networks (e.g., each access network). A separate measure may be made for uplink transmissions and downlink transmissions. The variability measure may be one or multiple of: a statistical variance of the delays, a statistical standard deviation of the delays, a median of the delays, a k-th percentile of the delays, the maximum delay observed, the minimum delay observed, etc. The primary access may be chosen as the access with the lower variability of delay.

The measurements may include a load. The load on the respective access networks (e.g., each access network) may be measured. It may be a measure of the over-the-air load, the transport network load (e.g., the load in core network on the N3/N9 interface to the UPF), or a combination of the over-the-air load and transport network load. The primary access may be chosen as the access with the lower load.

The network may trigger a change in primary access based on measurements and/or monitored events. The network may detect an overload event on the primary access or the secondary access (e.g., the 3GPP leg or non- 3GPP leg), and trigger a change in the primary access. For example, the load on one of the I-UPFs along one of the legs may cross a threshold. In some examples, the network may (e.g., decide to) add or remove an I-UPF along one of the legs. This may trigger the network to change the primary access.

A receiving entity may stop monitoring the secondary access.

In some examples, duplication for a redundant steering mode may be defined from the transmitting entity perspective. The transmitting entity may decide which PDUs to duplicate. For static_K duplication, K% of the PDUs may be duplicated over the secondary access, and the receiving entity may receive duplicate receptions of the same PDU. An ATSSS layer may have a deduplication function, for example, to deal with these duplicate receptions. In some examples, a deduplication function at layers above the ATSSS layer (for example the application) may be used or relied on to deal with the duplicate receptions.

In one or more examples herein, a receiving entity may stop monitoring the secondary access or stop processing received PDUs over the secondary access, for example, based on one or more conditions herein. In combination with relying on the deduplication functionality at the ATSSS layers and above, this approach may prevent the receiving entity from receiving the duplicate transmission when the receiving entity determines that duplication is not needed. This approach may be used for one or more of the static_100 duplication, static_K duplication, and/or dynamic duplication.

This determination that duplication may not be used (e.g., needed) may be made based on one or more of the following conditions.

This determination that duplication may not be used (e.g., needed) may be made based on measurements and/or QoS parameters (e.g., QoS requirements) being met. The receiving entity may monitor one or more of a PLR, a delay, a variability of delay, a load, etc. The receiving entity may determine that the primary access is meeting the QoS parameters (e.g., QoS requirements) of the service data flow. In some examples, the receiving entity may monitor the same metrics (e.g., on the secondary access) and/or may determine that the secondary access offers poor metrics/measurements (e.g., lower than a certain value) and/or that receiving PDUs on the secondary access may not meet the QoS parameters (e.g., QoS requirements) of the service data flow.

This determination that duplication may not be used (e.g., needed) may be made based on a battery status. The receiving entity may (e.g., decide to) stop monitoring the secondary access, for example, to save power. The receiving entity may have a low power (e.g., remaining battery power lower than a certain value).

This determination that duplication may not be used (e.g., needed) may be made based on a priority of the packet(s). The receiving entity may know that the next PDU or set of PDUs that are to be received are of low priority. The PDU(s) of the low priority may be dropped (e.g., if needed). The receiving entity may (e.g., decide to) stop monitoring the secondary access or processing received PDUs over the secondary access. The receiving entity may know the priority of the next PDUs, for example, based on traffic profile information or based on information carried in the PDU headers. For example, a PDU may indicate that the next upcoming PDU is of low priority.

A receiving entity may stop monitoring the secondary access if it determines that the receiving entity has no other SDFs using the secondary access.

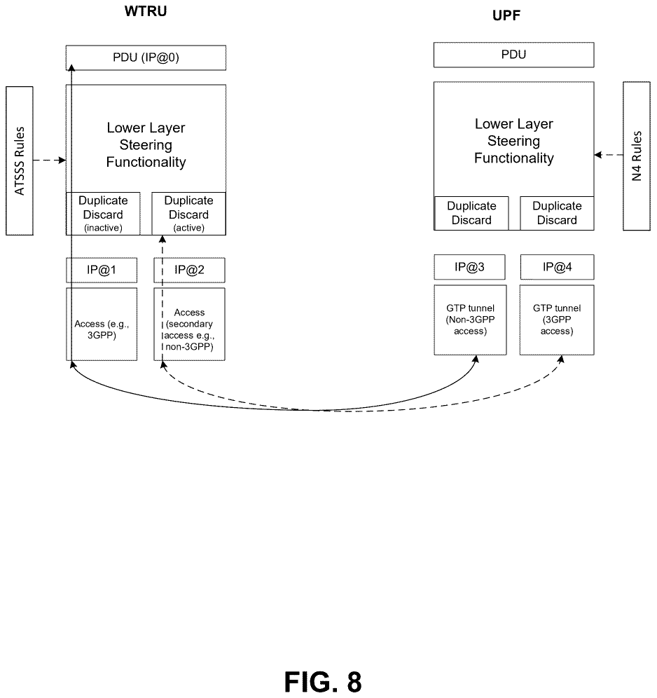

A receiving entity may stop processing received PDUs over the secondary access. The mechanism is described in FIG. 8 from the perspective of a WTRU as the receiving entity. FIG. 8 illustrates an example duplicate discard function for a WTRU. In the example shown in FIG. 8, the WTRU may have determined that it no longer needs to receive duplicate PDUs for an SDF, but the WTRU has other SDFs that are using the secondary access. The WTRU may not be able to stop monitoring the secondary access and may continue monitoring the secondary access. The WTRU may decide to discard the duplicate PDUs, for example, based on (e.g., upon) reception of a PDU. The ATSSS layer may have a Duplicate Discard functionality. The Duplicate Discard functionality may be active on the secondary access (e.g., only active on the secondary access). Based on measurements or a battery status or a priority of PDUs, the Duplicate Discard functionality may determine to stop processing packets on the secondary access for a service data flow. The PDUs received on the secondary access (e.g., all PDUs received on the secondary access) for this service data flow may be discarded. These PDUs may not be sent for further processing in the ATSSS layer.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1.-20. (canceled)

21. A wireless transmit/receive unit (WTRU) comprising:
a processor configured to:
receive configuration information associated with a multi-access protocol data unit (PDU-MA) session, wherein the configuration information indicates a primary access network, a duplication factor value, and a window size;
determine a ratio of duplicated protocol data units (PDUs) during a duration of time associated with the window size based on a first number of bytes included in a first set of PDUs and a second number of bytes included in a second set of PDUs, wherein the first set of PDUs are a set of PDUs that were transmitted via the primary access network during the duration of time, and wherein the second set of PDUs comprises a first set of duplicated PDUs that were transmitted during the duration of time;
determine whether to send a duplicated PDU via a secondary access network based on the ratio of the duplicated PDUs during the duration of time and a selected duplication factor value;
send via the primary access network a first PDU; and
send, based on the determination of whether to send the duplicated PDU via the secondary access network, a second PDU via the secondary access network, wherein the second PDU is the first PDU duplicated.

22. The WTRU of claim 21, wherein the determination of whether to send the duplicated PDU is further based on at least one of a duplication pattern, a duplication cycle, or a priority of the PDU.

23. The WTRU of claim 21, wherein the configuration information comprises rules associated with access traffic steering switch and splitting rules (ATSSS) for a static redundant steering mode, and wherein the ratio of duplicated PDUs during the duration of time associated with the window size is further determined based on the rules associated with ATSSS.

24. The WTRU of claim 21, wherein the duplication factor value is a first duplication factor value, and wherein the configuration information further indicates a second duplication factor value, wherein the selected duplication factor value is one of the first duplication factor value or the second duplication factor value.

25. The WTRU of claim 24, wherein the configuration information further indicates a first priority threshold associated with the first duplication factor value and a second priority threshold associated with the second duplication factor value, and wherein the processor is further configured to:
select a duplication factor value based on a priority associated with the first PDU.

26. The WTRU of claim 21, wherein the duration of time is associated with a rolling time window.

27. The WTRU of claim 21, wherein the determined ratio of duplicated PDUs is associated with a first service data flow (SDF).

28. The WTRU of claim 21, wherein the determined ratio of PDUs is the ratio of the second number of bytes included in the second set of PDUs to the first number of bytes included in the first set of PDUs.

29. The WTRU of claim 21, and wherein the processor is further configured to:
receive a third PDU via the primary access network; and
receive a fourth PDU via the secondary access network, wherein the fourth PDU is a duplicate of the third PDU.

30. The WTRU of claim 29, wherein the processor is further configured to:
determine that a mode associated with the WTRU is associated with power savings; and
determine to discard the fourth PDU based on the determination that the mode associated with the WTRU is associated with power savings.

31. A method comprising:
receiving configuration information associated with a multi-access protocol data unit (PDU-MA) session, wherein the configuration information indicates a primary access network, a duplication factor value, and a window size;
determining a ratio of duplicated protocol data units (PDUs) during a duration of time associated with the window size based on a first number of bytes included in a first set of PDUs and a second number of bytes included in a second set of PDUs, wherein the first set of PDUs are a set of PDUs that were transmitted via the primary access network during the duration of time, and wherein the second set of PDUs comprises a first set of duplicated PDUs that were transmitted during the duration of time;
determining whether to send a duplicated PDU via a secondary access network based on the ratio of the duplicated PDUs during the duration of time and a selected duplication factor value;
sending via the primary access network a first PDU; and
sending, based on the determination of whether to send the duplicated PDU via the secondary access network, a second PDU via the secondary access network, wherein the second PDU is the first PDU duplicated.

32. The method of claim 31, wherein the determination of whether to send the duplicated PDU is further based on at least one of a duplication pattern, a duplication cycle, or a priority of the PDU.

33. The method of claim 31, wherein the configuration information comprises rules associated with access traffic steering switch and splitting rules (ATSSS) for a static redundant steering mode, and wherein the ratio of duplicated PDUs during the duration of time associated with the window size is further determined based on the rules associated with ATSSS.

34. The method of claim 31, wherein the duplication factor value is a first duplication factor value, and wherein the configuration information further indicates a second duplication factor value, wherein the selected duplication factor value is one of the first duplication factor value or the second duplication factor value.

35. The method of claim 34, wherein the configuration information further indicates a first priority threshold associated with the first duplication factor value and a second priority threshold associated with the second duplication factor value, and wherein the method further comprises:
selecting a duplication factor value based on a priority associated with the first PDU.

36. The method of claim 31, wherein the duration of time is associated with a rolling time window.

37. The method of claim 31, wherein the determined ratio of duplicated PDUs is associated with a first service data flow (SDF).

38. The method of claim 31, wherein the determined ratio of PDUs is the ratio of the second number of bytes included in the second set of PDUs to the first number of bytes included in the first set of PDUs.

39. The method of claim 31, and wherein the method further comprises:
receiving a third PDU via the primary access network; and
receiving a fourth PDU via the secondary access network, wherein the fourth PDU is a duplicate of the third PDU.

40. The method of claim 39, wherein the method further comprises:
determining that a mode associated with a WTRU is associated with power savings; and
determining to discard the fourth PDU based on the determination that the mode associated with the WTRU is associated with power savings.
